(19) United States
(12) Patent Application Publication
(10) Pub. No.: US 2017/0275420 A1
(43) Pub. Date: Sep. 28, 2017

(54) Polyesters, Manufacturing Process Thereof and Their Use

(71) Applicant: WeylChem Wiesbaden GmbH, Wiesbaden (DE)

(72) Inventors: Paula Barreleiro, Ginsheim (DE); Hans Jürgen Scholz, Alzenau (DE); Andreas Schottstedt, Hofheim (DE); Roman Morschhäuser, Mainz (DE)

(21) Appl. No.: 15/461,650

(22) Filed: Mar. 17, 2017

(30) Foreign Application Priority Data
Mar. 22, 2016 (DE) 102016003544.7

(51) Int. Cl. C08G 63/688; C08G 63/78; C11D 11/00; C11D 3/37; C11D 3/00

(52) U.S. Cl. CPC C08G 63/6886; C11D 3/3715; C11D 3/0036; C11D 11/0017; C08G 63/78

(57) ABSTRACT

Disclosed are polyesters comprising structural units of formula Ia and end groups of formulae II and III or end groups of formulae II and IV or end groups of formulae II, III and IV or comprising structural units of formulae Ia and Ib and end groups of formulae II and III or end groups of formulae II and IV or end groups of formulae II, III and IV

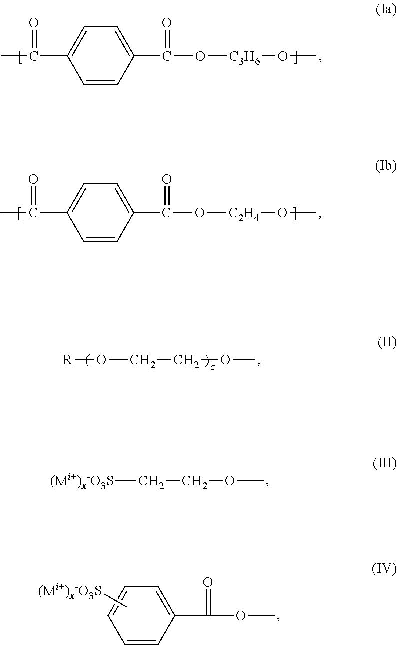

wherein R is C₁-C₄-alkyl,
M is hydrogen or a mono- or divalent cation,
i is 1 or 2,
x is 0.5 or 1 and the product i·x is equal to 1, and
z is an integer from 3 to 35.

The polyesters of the invention show a significantly improved dirt removal ability and can be used as soil-release polymers in washing and cleaning agents and in textile care products.

### CLAIM FOR PRIORITY

This application is based on German Patent Application No. 10 2016 003 544.7, filed Mar. 22, 2016, the priority of which is hereby claimed and the disclosure of which is incorporated herein by reference.

### TECHNICAL FIELD

The invention relates to selected polyesters which are suited as additives to detergents and to cleaning agents. These polyesters are characterised by superior dirt release; they are soluble in water, are substantially non-hygroscopic and are of firm, not sticky consistency.

### BACKGROUND

It is known to use of polyesters in detergents to improve dirt release in textiles, to reduce the resoiling, to protect the fibres under mechanical load and to equip the textile with an anti-crease effect. A variety of polyester types and their use in washing and cleaning products are described in the patent literature.

U.S. Pat. No. 4,702,857 A describes block copolyesters from ethylene glycol, 1,2-propylene glycol or mixtures thereof, polyethylene glycol with at least 10 glycol units that is terminated at one end with a short-chain alkyl group, especially with a methyl group, a dicarboxylic acid or ester thereof and optionally alkali salts of sulphonated aromatic dicarboxylic acids.

In U.S. Pat. No. 4,427,557 A polyesters with molecular weights in the range of 2.000 to 10.000 g/mol are disclosed which are made from the monomers ethylene glycol, poly-ethylene glycol with molecular weights from 200 to 1.000 g/mol, aromatic dicarboxylic acids and alkali salts of sulphonated aromatic dicarboxylic acids and optionally from small amounts of aliphatic dicarboxylic acids, such as glutaric acid, adipic acid, succinic acid, pimelic acid, suberic acid, azelaic acid, sebacic acid and 1,4 cyclohexanedicarboxylic acid and their anti-crease effect and soil release effect on polyester fabric or on polyester cotton blended fabric is advertised.

U.S. Pat. No. 4,721,580 A discloses polyesters with terephthalate units and sulfo-containing end groups, especially sulfoethoxylated end groups MO₃S(CH₂CH₂O)ₙ—H and advertises their use in detergents and in fabric softeners.

U.S. Pat. No. 4,968,451 A describes polyesters with sulfo-containing end groups obtained by copolymerization of (meth)allyl alcohol, alkylene oxide, aryldicarboxylic acid and C₂-C₄ glycol and subsequent sulfonation.

WO 96/18715 A2 describes soil release polymers with branched backbone of di- or polyhydroxysulfonate with at least 3 functional groups, preferably derived from glycerol, terephthalate- and 1,2-oxyalkyleneoxy-units with non-ionic and anionic end groups.

U.S. Pat. No. 5,415,807 A sets out that soil release polymers (SRP) with sulfonated polyethoxy/propoxy end groups tend to crystallisation resulting in a reduction of the soil release effects. This document teaches that the tendency to crystallization of the SRP can be reduced by addition of hydrotropes selected from the group of alkyl benzene sulfonates, such as sodium dodecylbenzene sulfonate, sodium cumol sulfonate, sodium toluene sulfonate, sodium xylene sulfonate or even linear or branched alkyl sulfonates with 4 to 20 carbon atoms.

U.S. Pat. No. 5,691,298 claims soil release polymers with branched backbone of di- or polyhydroxysulfonate, terephthalate- and 1,2-oxyalkylenoxy units with non-ionic and anionic end groups, wherein the anionic end groups contain more than 2 carbon atoms.

DE199 06 367 A1 describes the use of comb polymers as soil release polymers obtained by condensation of a polycarboxylic acid or a poly alcohol, one or more optionally sulfo group substituted poly alcohols with 2-4 OH groups or polyglycols of the formula HO—(XO)ₐ—H, where X is C₂H₄ and/or CO₃H₇ and a is a number from 2 to 35, one or more C₂-C₁₀ dicarboxylic acids and one or more compounds of the formula NH₂R, NHR₂, ROH, R¹COOH, HO(XO)_{b}—H, HO(CH₂CH₂)_{d}SO₃K wherein R is C₁-C₂₂-alkyl, C₆-C₁₀-aryl, R¹ is C₁-C₂₂-alkyl, C₁-C₂₂-sulfoalkyl, C₆-C₁₀-aryl or C₆-C₁₀-sulfoaryl, X is C₂H₄ and/or CO₃H₇, b is a number between 3 and 40, d is a number from 1 to 10, and K is a cation.

WO 98/05747 A1 describes a process for the manufacture of granulates comprising polyesters which are not end-capped or which can carry at one end or at both ends of the polymer chain sulfoaroyl- or sulfonated polyethoxy/propoxy end groups, and alkyl aryl sulfonates or alkyl sulfonates and ethoxylated fatty alcohols. The tendency towards crystallization of the polyesters is reduced and the soil release effect is improved.

U.S. Pat. No. 5,599,782 A describes solid detergents containing polyesters from the monomers sulfobenzoic acid, dimethyltherephthalate, dimethylsulfoisophthalate and ethylene glycol, but no propylene glycol or higher glycols.

WO 94/22937 A1 describes detergents containing sulfonated ester oligomers. These contain end groups which are selected from sulfobenzoyl- or MO₃(CH₂)ₘ(CH₂CH₂O)(RO)ₙ-groups, with m being 1 or 2, n being between 0 and 4 and R being ethylene or propylene, and which contain other structural units derived from terephthalate and sulfoisophthalate, as well as ethylene glycol and/or propylene glycol.

EP 1 966 273 B1 discloses additives for detergents with soil release properties. These additives are based on sulfonated alkylene isophthalate and on alkylene terepthalate units with non-ionic alkylpolyglykol end groups, provided the number of glycol units in the end groups does not exceed five. These additives show excellent soil release properties, but are prone to moisture absorption, making difficult their workability in particular during compaction or granulation.

WO 2011/063944 A1 corresponding to EP 2 504 380 A1 teaches polyesters obtainable through polymerization of one or more aromatic dicarboxylic acids free of sulfo groups or their esters, with optionally one or more sulfo group containing dicarboxylic acids or their esters, with 1,2-propylene glycol (PO), ethylene glycol (EO), where the ratio of PO to EO is >1.7, one or more compounds of the formula R¹O(CHR²CHR³O)ₙH, wherein R¹ is a linear or branched, saturated or unsaturated alkyl group with 1 to 22 C-atoms, R² and R³ independently of one another are hydrogen or an alkyl group with 1 to 4 carbon atoms, and n is a number from 1 to 50, and optionally one or more compounds of the formula H—(OCH₂CH₂)ₘ—SO₃X, wherein m is a number from 1 to 10 and X is hydrogen or an alkali metal atom. These polyesters are distinguished by a good solubility and/or dispersibility in water, by a sufficiently resistance to hydrolysis, and they largely retain a thin consistency in dissolved form even during long term storage and they do not tend to hygroscopicity.

So far known anionic soil release polymers are not fully satisfying with regard to soil release effect, water solubility, dispersibility, hydrolytic stability, and in terms of solid non-sticky consistency.

At low wash temperatures, the soil release polymers dissolve not or only insufficiently and remain partially on the clothes as a whitish residue. Also, dirt release behavior is not fully developed.

Another problem is the tendency of these polymers to hydrolysis in aqueous systems, as well as the precipitation of SRP's or the phase separation in liquid compositions, as well as a sticky or crystalline, glassy brittle consistency of these polymers.

So far, known anionic soil release polymers with sulfo-containing groups are characterized by a good water solubility, however tend to hygroscopicity and to stickiness. A direct grinding of the solidified polyester melt by hammer, screening or so-called roller mills is not possible. The high intake of water during the grinding process leads to agglutination and to the collapse of the continuous operation. Even if acceptable results can be achieved by using special, energy-intensive processes, such as low temperature grinding (cryo-grinding) or spray drying processes from aqueous solution, the storage stability of anionic SRP-granulates remains limited because of the water absorption capacity.

Object of the present invention is to provide anionic polyesters, which are well soluble and/or dispersible, show good soil release effect and high dispersing capacity, are sufficiently stable to hydrolysis, are compatible with additives and auxiliary materials commonly used in detergents and cleaning agents and which can be transformed by grinding into particles with low dust content and homogenous particle size distribution.

Now surprisingly, we found that these problems are solved by the polyesters defined below.

### SUMMARY OF INVENTION

The polyesters of the invention show a significantly improved dirt removal ability, in particular to oily and greasy stains, are characterised by very good dissolution properties already at a temperature of 20° C. and can be presented as well storage-stable, free-flowing granulates and can be incorporated in solid, free-flowing preparations. The polyesters of the invention have a glassy to opaque appearance, preferably an opaque appearance and can be ground easily to particles with desired particle size distribution. Very fine portions can be returned to the manufacturing process and show no degradation and color change.

The invention relates to polyesters comprising structural units of formula Ia and end groups of formulae II and III or end groups of formulae II and IV or end groups of formulae II, III and IV or comprising structural units of formulae Ia and Ib and end groups of formulae II and III or end groups of formulae II and IV or end groups of formulae II, III and IV

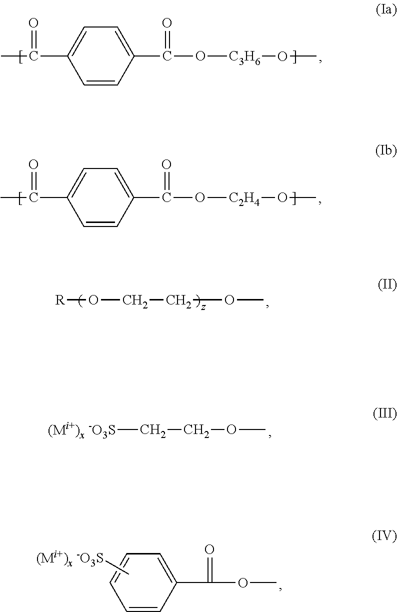

wherein R is C₁-C₄-alkyl and preferable methyl,

M is hydrogen or a mono- or divalent cation,

i is 1 or 2,

x is 0.5 or 1 and the product i·x is equal to 1, and

z is an integer from 3 to 35, preferably from 10 to 20 and very preferred of 12 to 18.

Preferred polyesters of the invention comprise besides the structural units of formula Ia or of formulae Ia and Ib and the end groups of formulae II and III or of formulae II and IV or of formulae II, III and IV the structural units of formulae Va and/or VIa or the structural units of formulae Va and Vb and/or of formulae VIa and VIb

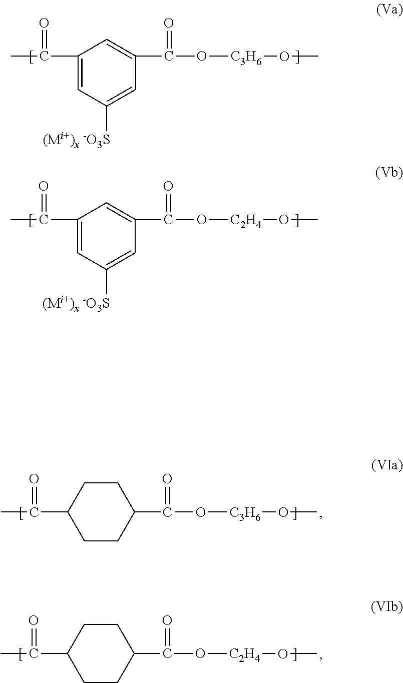

wherein M is hydrogen or a mono- or bivalent cation,

i is 1 or 2,

x is 0.5 or 1 and the product i·x is equal to 1.

The propylene glycol units —C₃H₆— can have the structure —CH₂—CH₂—CH₂— or preferably have the structure —CH(CH₃)—CH₂—.

The polyesters of the invention are characterised by having structural units of the formula Ia and/or of the formulae Ia and Ib, as well as having selected combinations of end groups.

The molecular weights of the polyesters of the invention are in the range of 2.000 g/mol to 20.000 g/mol, preferably 2.500 g/mol to 12.000 g/mol, particularly preferred of 3.000 g/mol to 8.000 g/mol.

The generation of the desired molecular weights can be performed by selecting the proportions of individual monomers. This procedure is known to the skilled person.

The weight average of the molecular weight is determined by the means of size exclusion chromatography in aqueous solution using a calibration by means of closely distributed polyacrylic acid sodium salt standard.

Particularly preferred polyesters of the invention contain >3, preferably >=6 terephthalate-units of formula Ia or put together of formulae Ia and Ib in the molecule.

A preferred embodiment of the invention are polyesters comprising the structural units of formula Ia or of formulae Ia and Ib and end groups of formula II, wherein R is a methyl group and index z is a number from 8 to 22, preferably from 10 to 20, and especially preferred from 12 to 18, as well as end groups of formula III and/or of formula IV.

A more preferred embodiment of the invention are polyesters comprising structural units of formula Ia or of formulae Ia and Ib and end groups of formula II and end groups of formula III.

Another preferred embodiment of the invention are polyesters comprising structural units of formula Ia or of formulae Ia and Ib and end groups of formulae II, III and IV.

In a more preferred embodiment the polyesters of the invention comprise structural units of formula Ia and end groups of formulae II and IV or structural units of formulae Ia and Ib and end groups of formulae II and IV.

In another preferred embodiment the polyesters of the invention comprise structural units of formulae Ia and Va and end groups of formulae II and III, but preferably no end group of formula IV and no structural unit of formula Via, or comprise structural units of formulae Ia, Ib, Va and Vb and end groups of formulae II and III, but preferably no end group of formula IV and no structural units of formulae Via and VIb.

A very preferred embodiment are polyesters containing the structural units of formula Ia or of formulae Ia and Ib and end groups of formulae II and III, wherein these end groups are derived from the reaction with polyethylene glycol monomethylether and isethionic acid, or any of its salts, in the mole ratio II to III from 1 to 50 to 50 to 1, preferred from 1 to 10 to 10 to 1, especially from 1 to 5 to 5 to 1.

A further particularly preferred embodiment of the invention relates to copolyesters containing structural units of formulae Ia and Va or containing structural units of formulae Ia, Ib, Va and Vb.

Particularly preferred the structural units of formulae Ia and Va are present in the molar ratio from 1 to 1 to 10 to 1, preferably from 2 to 1 to 5 to 1, or the structural units of formulae Ia, Ib, Va and Vb are present in the molar proportion of Ia+Ib to Va+Vb from 1 to 1 to 10 to 1, preferred from 2 to 1 to 5 to 1.

Especially preferred are polyesters in which the group SO₃M in the end group of formula IV is in 3-position and M is hydrogen or an alkali metal cation and/or earth alkali metal ion.

The polyesters of the invention can be crosslinked or preferably are not crosslinked.

The molar proportion of crosslinking structural units, relative to the total amount of structural units in the polyester, is 0 to 5 mol %, preferably 0 to 3 mol % and especially preferred 0 to 1 mol %.

Crosslinking structural units are to be understood within the framework of this description as structural units, that have at least three functionalities, such as oxygen or carboxylic acid bridges and which link covalently together at least two polyester chains.

Crosslinking structural units in the polyesters of the invention can be those of formula VII

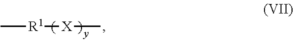

wherein

y is an integer from 3 to 6,

R¹ is a three- to six-valent organic residue, preferably a three- to six-valent alkyl- or aryl-residue, and

X is —O— and/or —COO—.

Preferably preferred are non-crosslinked polyesters.

M is preferably hydrogen or an alkali or earth alkali metal cation, in particular hydrogen or an alkali metal cation, and particularly favored hydrogen or a sodium or potassium cation.

The polyesters of the invention are characterized by an excellent solubility and dispersibility in water.

More preferred polyesters are characterised by a solubility and/or dispersibility in water at 25° C. of >0.05 g/l, most preferably of 0.5 g/l to 500 g/l.

More preferred polyesters are characterised by the fact that they can be administered as stable aqueous dispersions with a weight percentage of the polyesters of the invention by preferably 5.0 to 50.0 weight-%, especially preferred 10.0 to 40.0 weight-% and in particular preferred 15.0 to 30.0 weight-%, each based on the total weight of the finished aqueous dispersion.

In a particularly preferred embodiment of the invention, the aqueous dispersions consist of one or the more polyester(s) of the invention and water.

In another preferred embodiment the polyesters of the invention are colored and have been manufactured by polycondensation of monomers for the formation of the above-mentioned structural units in the presence of one or more pigment(s).

The production of colored polyesters can be performed as described in EP 2 552 994 A1.

The manufacture of the colored polyesters of the invention can be also performed in such a way that after the condensation of the above-mentioned monomers one or more pigments are added and are mixed with the condensation product.

The synthesis of the polyesters of the invention may be effected according to known procedures, by pre-esterification of the monomers required for the setup of the desired polyester and optionally one or more pigments under addition of a catalyst, and a salt of a short-chain carboxylic acid, preferably acetate, first at atmospheric pressure at temperatures from 160 to 220° C. under an inert atmosphere.

Subsequently the desired molecular weight can be established through distillation of hyperstoichiometric amounts of the deployed glycols in vacuum at temperatures from 160 to about 240° C.

Further details and preferred aspects of the invention are discussed below.

### DETAILED DESCRIPTION

The known transesterification and condensation catalysts of the state of the art can be used for the reaction, such as titanium tetraisopropylate, dibutyl tin oxide, alkaline or earth alkaline metal alcoholates, or antimony trioxide/calcium acetate.

For further details on the implementation of the polycondensation reference is made to EP 442 101 A1.

Preferably the preparation of the polyesters of the invention is performed by reacting
a) terephthalic acid dimethyl ester,
b) propylene glycol or ethylene glycol and propylene glycol,
c) polyethylene glycol monomethyl ether with a weight-average molecular weight in the range between 174 and 1555 g/mol, preferably between 500 and 800 g/mol and very preferred of 550 g/mol or of 750 g/mol,
d) isethionic acid or one of its salts, preferably its alkaline- or earth alkali metal salts and/or
e) sulfobenzoic acid, salts, preferably its alkali- or earth alkali metal salts, preferably 3-sulfobenzoic acid sodium salt
f) optionally sulfoisophthalic acid dimethylester and
g) optionally 1,4-cyclohexane dicarboxylic acid dimethylester

wherein preferably besides components a), b), c) and d) or besides components a), b), c) and e) or besides components a), b), c), d) and e) at least one of the components f) and/or g) are additionally used in the reaction.

Preferably 1,2-propylene glycol is used as propylene glycol.

As polyethylene glycol monomethyl ether preferably polyethylene glycol monomethyl ether with a weight-average molecular weight in the range from 500 to 800 g/mol, preferably 550 g/mol and 750 g/mol, is used.

The structural units of formula Ia can be obtained by reacting the above cited component a) terephthalic acid dimethylester with component b) propylene glycol; the structural units of formulae Ia and Ib can be obtained by reacting the above cited component a) terephthalic acid dimethylester with components b) propylene glycol and ethylene glycol.

The end group of formulae II, III, and IV can be obtained by reaction with the above mentioned components c), d) and e).

In a particular embodiment of the invention for preparation of the polyesters of the invention components c) and d) are reacted in a molar ratio from 1 to 10 to 10 to 1, preferred from 1 to 5 to 5 to 1, and very preferred from 1 to 2 to 2 to 1.

In an equally particularly preferred embodiment of the invention for preparation of the polyesters of the invention components c) and e) are reacted in a molar ratio from 1 to 10 to 10 to 1, preferred from 1 to 5 to 5 to 1, and very preferred from 1 to 2 to 2 to 1.

In an equally preferred embodiment of the invention for preparation of the polyesters of the invention component c) and a mixture of d) and e) are reacted in a molar ratio c) to (d)+e)) from 1 to 10 to 10 to 1, preferred from 1 to 5 to 5 to 1, and very preferred from 1 to 2 to 2 to 1.

The polycondensation can occur in the presence or in the absence of one or more crosslinking acting compounds h). Preferred crosslinkers include three to six functions qualified for polycondensation, in particular acid-, alcohol- or ester-functions.

Polycondensation reactions are preferred where monomers a) to d) and f) are reacted in the absence of a monomer g) and in absence of components of h) and i); or where monomers a) to c), e) and f) are reacted in the absence of monomer g) and in the absence of components h) and i); or where monomers a) to f) are reacted in the absence of monomer g) and in absence of components h) and i).

Additional preferred polycondensation reactions relate to the reaction of monomers a) to d) and f) in following molar ratios, each related to 1 mol of component a), terephthalic acid dimethylester:

monomer(s) b): 1 to 25.0 moles, preferably 2 to 22 moles, especially preferred 4 to 21 moles, particularly preferred 5 to 20 moles per mol of a), and

monomer c): 0.01 to 1.0 moles, preferably 0.02 to 0.8 moles, especially preferred 0.05 to 0.5, particularly preferred 0.1 to 0.5 moles per mol of a),

monomer d): 0.001 to 0.8 moles, preferably 0.005 to 0.5 moles, especially preferred 0.05 to 0.4 moles, particularly preferred 0.1 to 0.3 moles per mol of a) and

monomer f): 0.01 to 3 moles, preferably 0.05 to 2 moles, especially preferred 0.1 to 1.5 moles per mol of a),

with the proviso that the molar ratios of the monomers a) to (d) and f) are chosen in a manner, that polymers with molecular weights in the range from 2.000 g/mol to 20.000 g/mol are obtained.

More preferred polycondensation reactions relate to the reaction of monomers a) to c), e) and f) in following molar ratios, each related to 1 mol of component a), terephthalic acid dimethylester:

monomer(s) b): 1 to 25.0 moles, preferably 2 to 22 moles, especially preferred 4 to 21 moles, particularly preferred 5 to 20 moles per mol of a), and

monomer c): 0.01 to 1.0 moles, preferably 0.02 to 0.8 moles, especially preferred 0.05 to 0.5 moles, particularly preferred 0.1 to 0.5 moles per mol of a),

and

monomer e): 0.001 to 0.8 moles, preferably 0.01 to 0.7 moles, especially preferred 0.05 to 0.6 moles, particularly preferred 0.1 to 0.5 moles per mol of a), and

monomer f): 0.01 to 3 moles, preferably 0.05 to 2 moles, especially preferred 0.1 to 1.5 moles per mol of a),

with the proviso that the molar ratios of the monomers a) to c), e) and f) are chosen in a manner, that polymers with molecular weights in the range from 2.000 to 20.000 g/mol are obtained.

Additional preferred polycondensation reactions relate to the reaction of monomers a) to f) in following molar ratios, each related to 1 mol of component a), terephthalic acid dimethylester:

monomer(s) b): 1 to 25.0 moles, preferably 2 to 22 moles, especially preferred 4 to 21 moles, particularly preferred 5 to 20 moles per mol of a), and

monomer c): 0.01 to 1.0 moles, preferably 0.02 to 0.8 moles, especially preferred 0.05 to 0.5 moles, particularly preferred 0.1 to 0.5 moles per mol of a), and

monomer d): 0.001 to 0.8 moles, preferably 0.01 to 0.7 moles, especially preferred 0.05 to 0.6 moles, particularly preferred 0.1 to 0.5 moles per mol of a), and

monomer e): 0.001 to 0.8 moles, preferably 0.01 to 0.7 moles, especially preferred 0.05 to 0.6 moles, particularly preferred 0.1 to 0.5 moles per mol of a), and

monomer f): 0.01 to 3 moles, preferably 0.05 to 2 moles, especially preferred 0.1 to 1.5 moles per mol of a),

with the proviso that the molar ratios of the monomers a) to f) are chosen in a manner, that polymers with molecular weights in the range of 2.000 to 20.000 g/mol are obtained.

If crosslinkers i) are involved during the polycondensation these are preferably used in quantities from 0.00001 to 0.1 moles, in particular from 0.00002 to 0.01 moles, and particularly preferred from 0.00005 to 0.0001 moles per mol of a).

The polyesters of the invention can be used in different dosage forms. Examples include granulates, tablets, gels, aqueous dispersions or aqueous solutions.

Subject-matter of the invention is also the use of the polyesters of the invention in washing and cleaning agents, textile care products and products for textile finishing.

The polyesters of the invention confer significantly improved dirt-removal properties to textile fibers and substantially support the soil release capacity of other detergent components towards oily, greasy or pigment soils.

Another advantage is the use of the polyesters of the invention in aftertreatment agents for laundry, for example, in a fabric conditioner.

Using the polyesters of the invention in cleaning agents for surfaces, especially for hard surfaces, the treated surfaces can be equipped dirt repellent.

The invention also relates to the use of the above described polyesters as soil-release-polymers.

The washing, care and cleaning agent formulations, in which the polyesters of the invention can be used, can be in the form of a powder, a granulate, a tablet, a paste, a gel or a liquid.

Examples include all purpose detergents, mild detergents, color detergents, wool detergents, curtain detergents, modular detergents, washing tablets, bar soaps, stain salts, starches and stiffening agents and ironing aids.

The polyesters of the invention can also be incorporated in household cleaning agents, for example in all-purpose cleaners, or in dishwashing products, in carpet-cleaning and impregnation agents, in cleaning and care products for floors and other hard surfaces, such as from plastic, ceramic, glass or surfaces coated with nano-technology.

Examples of technical cleaning agents are plastic cleaners and care agents, for example for housings and car fittings, as well as cleaning and care agents for painted surfaces such as car bodies.

The laundry, care and cleaning agents equipped according to the invention contain in general at least 0.1 weight-%, preferably between 0.1 and 10 weight-% and especially preferred 0.2 to 3% weight-% polyester of the invention, based on the finished agents.

Depending on the intended use the formulations are to be adjusted in their composition to the type of textile to be treated or to be washed or to the surfaces to be cleaned.

The washing, care and cleaning products equipped according to the invention may contain commonly used ingredients, such as surfactants, emulsifiers, scaffold materials, bleaching catalysts and bleaching activators, sequestering agents, graying inhibitors, dye-transfer inhibitors, color fixatives, enzymes, optical brighteners, softening components. Also, the formulations or parts thereof within the meaning of the invention can be selectively colored and/or perfumed by dyes and/or fragrances.

The following examples serve to explain the invention without limiting it. All references to percentages are to be understood as percent by weight (weight-%), unless not explicitly stated otherwise.

### Example 1 (Polyester of the Invention)

194.1 g (1.00 mol) terephthalic acid dimethylester, 88.8 g (0.3 moles) 5-sulfo-isophthalic acid dimethylester sodium salt, 235.4 g (3.8 moles) ethylene glycol and 144.4 g (1.9 moles) 1,2-propylene glycol were successively added into a 2-liter four-necked round bottom flask equipped with KPG-stirrer, internal thermometer, gas inlet tube and distilling link. Subsequently additional 8.88 g (0.06 moles) isethionic acid sodium salt and 45 g polyethylene glycol monomethylether 750 (0.06 moles) were added to the reaction mixture.

Then, the reaction mixture was inerted by introducing nitrogen. In counterflow subsequently 2 g of titanium tetraisopropylate and 1 g of sodium acetate were added to the reaction mixture. The mixture was heated to about 165° C. and kept for an hour on temperature. At this temperature the transesterification began and the resulting methanol was distilled.

Two hours after start of the distillation the temperature was increased to 210° C. within 1 h. After finished reaction time it was cooled below 195° C. and the pressure was reduced within 30 minutes to 10 mbar. During the subsequent two-hour vacuum distillation, condensation was complemented by distillation of the excess amount of alcohol. For additional 30 minutes, the vacuum was reduced to 1 mbar, then vented with nitrogen and the melt was discharged to suitable sheets.

### Example 2 (Polyester of the Invention)

555.48 g (3.75 moles) terephthalic acid dimethylester, 125.9 g (0.5 moles) 5-sulfo-isophthalic acid dimethylester sodium salt and 1162 g (20 moles) 1,2-propylene glycol were successively added into a 2-liter four-necked round bottom flask equipped with KPG-stirrer, internal thermometer, gas inlet tube and distilling link. Subsequently 215.37 g (1.00 mol) 3-sulfobenzoic acid sodium salt were added. Finally, 110 g polyethylene glycol monomethylether 550 were added to the reaction mixture.

Then, the reaction mixture was inerted by introducing of nitrogen. In counterflow subsequently 2 g of titanium tetraisopropylate and 1 g of sodium acetate were added to the reaction mixture. The mixture was heated to about 165° C. and kept for an hour on temperature. At this temperature the transesterification began and the resulting methanol was distilled.

One hour after start of the distillation the temperature was increased to 210° C. within 2 h. After finished reaction time it was cooled below 195° C. and the pressure was reduced within one hour to 5 mbar. During the subsequent two-hour vacuum distillation, condensation was complemented by distillation of the excess amount of alcohol. For additional 20 minutes, the vacuum was reduced to 5 mbar, then vented with nitrogen and the melt was discharged to suitable sheets.

### Example of 3 (Polyester of the Invention)

72.8 g (0.375 moles) terephthalic acid dimethylester, 37.03 g (0.125 moles) 5-sulfo-isophthalic acid dimethylester sodium salt, 62.07 g (1 mol), ethylene glycol, 76.09 g (1 mol) 1,2-propane diol, 37.13 g (0.0675 moles) polyethylene glycol monomethyl ether (molar mass 550 g/mol), 10 g (0.0675 moles) 2-hydroxyethane sulfonic acid sodium salt and 0.45 g (0.0056 moles) waterfree sodium acetate were furnished into a 1-liter four-necked round bottom flask equipped with KPG-stirrer, internal thermometer, Vigreux column, distilling link, nitrogen transfer line (5 liter/h) and Anschitz-Thiele piping and the reaction mixture was subsequently heated to 60° C. inside temperature under nitrogen overlay (5 liters/hour) and stirring at a stirring rate of 50-100 rpm. After closure of the nitrogen overlay 0.75 g (0.0027 moles) of titanium tetraisopropylate were added. Subsequently, the stirring rate was increased to 300 rpm and the preparation was heated to 150° C. inside temperature within 2 hours and to an inside temperature of 200° C. within additional 2 hours. At an inside temperature of 170° C. the nitrogen overlay was opened again. The reaction mixture was heated for 2 hours at 200° C. and the resulting methanol was distilled and was condensed in a collecting tray cooled with ice.

At the end of the methanol removal the vacuum was progressively lowered to 5 mbar and thereby excess glycol was distilled. The internal temperature was increased to 220° C. maximum. After termination of the glycol removal it was condensed for additional 2 hours at 5 mbar. Subsequently, it was vented with N₂ and the melt was discharged on sheets.

### Examples 4 to 10 (Polyesters of the Invention) and Comparative Examples V-1 to V-4

One proceeded as indicated for the manufacture of the polyester in example 1 and reacted the components listed in the table below.

In all cases 5 g titanium tetraisopropylate was used as transesterification catalyst and 3 g of sodium acetate were used.

Table Ia of the ingredients (in g amounts) of the polyesters of
examples 4 to 10 and of comparative examples V-1 to V-4

| | | | | | 3- | Isethionic | | MPEG |
|---|---|---|---|---|---|---|---|---|
| polyester | 5-SIM*⁾ | DMT*⁾ | EG*⁾ | PG*⁾ | SBS*⁾ | acid*⁾ | MPEG*⁾ | type |
| no. | (g) | (g) | (g) | (g) | (g) | (g) | (g) | (g/mol) |
| 4 | 123 | 242 | 206 | 253 | 22.37 | 20.72 | 55 | 550 |
| 5 | 370 | 728 | 496 | 760 | 302 | — | 150 | 750 |
| 6 | 370 | 728 | 620 | 608 | 156.6 | — | 112.5 | 750 |
| 7 | 370 | 728 | 496 | 760 | — | 15 | 275 | 550 |
| 8 | 0 | 1044 | 620 | 760 | 111.8 | 8.88 | 33 | 550 |
| 9 | 148 | 728 | 806 | 380 | — | 4.44 | 300 | 750 |
| 10 | 148 | 728 | 62 | 1444 | — | 1.48 | 375 | 750 |
| V-1 | 148 | 728 | 1224 | 0 | — | 74 | 375 | 750 |
| V-2 | 148 | 728 | 310 | 760 | — | 37 | 200 | 2000 |
| V-3 | 88.8 | 194.1 | 235 | 144.8 | — | 17.76 | — | |
| V-4 | 266.2 | 97.0 | 322.4 | — | 33.35 | — | 0.1 | 2000 |

Table Ib of the ingredients (in molar amounts) of the polyesters of examples 4 to 10
and of comparative examples V-1 to V-4

| | | | | | | isethionic | | MPEG |
|---|---|---|---|---|---|---|---|---|
| polyester | 5-SIM*⁾ | DMT*⁾ | EG*⁾ | PG*⁾ | 3-SBS*⁾ | acid*⁾ | MPEG* | type |
| no. | (mol) | (mol) | (mol) | (mol) | (mol) | (mol) | (mol) | (g/mol) |
| 4 | 0.42 | 0.82 | 3.3 | 3.3 | 0.10 | 0.14 | 0.1 | 550 |
| 5 | 1.25 | 2.46 | 8 | 10 | 1.35 | — | 0.2 | 750 |
| 6 | 1.25 | 2.46 | 10 | 8 | 0.70 | — | 0.15 | 750 |
| 7 | 1.25 | 2.46 | 8 | 10 | — | 0.10 | 0.5 | 550 |
| 8 | 0 | 3.53 | 10 | 10 | 0.50 | 0.06 | 0.06 | 550 |
| 9 | 0.5 | 2.46 | 13 | 5 | — | 0.3 | 0.4 | 750 |
| 10 | 0.5 | 2.46 | 1 | 19 | — | 0.01 | 0.5 | 750 |
| V-1 | 0.5 | 2.46 | 20 | — | — | 0.5 | 0.5 | 750 |
| V-2 | 0.5 | 2.46 | 5 | 10 | — | 0.25 | 0.1 | 2000 |
| V-3 | 0.3 | 1.00 | 3.8 | 1.9 | — | 0.12 | — | — |
| V-4 | 0.9 | 0.5 | 5.2 | — | 0.15 | — | 0.1 | 2000 |

^{*)}5-SIM = 5-sulfoisophthalic acid dimethylester sodium salt DMT = dimethyl terephthalate EG = ethylene glycol PG = 1,2-propylene glycol 3-SBS = 3-sulfobenzoic acid sodium salt Isethionic acid = 2-hydroxyethane sulfonic acid sodium salt MPEG = polyethylene glycol monomethyl ether

The polyesters of the invention have a slightly opalescent, glass-like consistency and show a good solubility in demineralized water.

The polyesters of the invention were of firm consistency and could be milled easily into powders, in particular with a sieve mill to result in particle sizes with narrow particle size distribution and with low dust content.

Fine portions incurred by the milling process, can be fed into the production process and further reacted.

The polyesters of the invention showed no tendency to hygroscopicity and no tendency to stickiness even after storage for many weeks.

The polyesters of V-1 (containing no propylene glycol structural units) and of V-2 (containing nonionic end groups derived from polyethylene glycol monomethyl ether with high content of ethyleneglycol structural units) not in accordance with the invention were of sticky consistency and could not be milled.

The polyester of V-3 (containing no nonionic end groups, but only anionic end groups, derived from the isethionic acid) not in accordance with the invention showed very high melt viscosities with >1 Mio mPas and could not be discharged from the reactor to plates.

The polyester of V-4 containing the anionic end group derived from 3-sulfobenzio acid and the nonionic end group derived from methyl polyethylene glycol MPEG 2000 not in accordance with the invention is of sticky consistency and shows a not satisfying washing result.

The polyesters of the invention comprising nonionic and anionic end groups are distinguished by a very good graying-inhibiting action (soil release action).

TABLE II
Washing results with the polyesters of the invention compared
to prior art soil release polyesters in the washing powder Spee
Aktiv Pulver (UBA 0416 8282), Dirty Motor Oil (DMO) test using
test fabric WFK 30A PES at a washing temperature of 20° C.

| Spee Aktiv Pulver (UBA 0416 8282) | Remission (%) |
|---|---|
| without additive | 18.1 |
| +1% soil release polymer: | |
| ®TexCare SRA 300 F | 24.1 |
| polyester of the invention, example 1 | 25.2 |
| comparative example V-4 | 20.4 |

TABLE III
washing conditions

| | |
|---|---|
| washing machine: | Linitest, 1x pre- |
| | equipped |
| water hardness: | 15° dH |
| Ca:Mg | 3:2 |
| lobe WFK 30A PES, 25 μl spent motor | 4 |
| oil per lobe | |
| liquor ratio | 1:40 |
| washing temperature | 20° C. |
| washing duration | 30 Min. |
| washing agent concentration | 4.6 g/l |

The polyesters of the invention were compared with soil release polymers of the prior art with regard to their soil release effect. For this purpose the polyesters were added to the suds in concentrations of 1% (active ingredient), referring the detergent formulation Spee active powder (UBA 0416 8282), and the test tissues WFK 30A PES (laundry Research Institute Krefeld) were pre-washed with this. The thus pretreated tissues were dried and were soiled with motor oil (using 25 μl per test cloth). After a exposure time of 1 hour the test clothes were washed without addition of the polyesters of the invention or of soil release polymers of the prior art. Then, the remission of the test tissues was measured.

### Formulation Examples

The polyesters of the invention can be used in solid detergents and cleaning agents and in detergents and cleaning agents in multiple-chamber systems for cleaning of textiles, as well as for surface cleaning agents.

Examples of this are:

Washing Powder, Phosphate-Free with Bleach

| | |
|---|---|
| alkyl benzene sulfonate, sodium-salt | 8.8% |
| C₁₂-C₁₈-alcohol ethoxylate with 7 EO | 4.7% |
| soap | 3.2% |
| foam inhibitor DC2-4248S, Dow Corning | 3.9% |
| zeolite 4A | ad 100% |
| soda | 11.6% |
| polyester, example 1 | 2.0% |
| polycarboxylate (Sokalan ® CP5) | 2.4% |
| sodium silicate | 3.0% |
| carboxymethylcellulose | 1.2% |
| phosphonate (Dequest 2066) | 2.8% |
| optical brightener | 0.2% |
| sodium sulfate | 6.5% |
| protease Savinase 8.0, Novo Nordisk | 0.4% |
| TAED | 5.0% |
| sodium percarbonate | 18.0%. |

Washing Powder, Phosphate-Containing without Bleaching Agent

| | |
|---|---|
| alkyl benzene sulfonate, sodium-salt | 8.0% |
| C₁₂-C₁₈-alcohol ethoxylate with 14 EO | 2.9% |
| soap | 3.5% |
| sodium tripolyphosphate | 43.8% |
| sodium silicate | 7.5% |
| magnesium silicate | 1.9% |
| polyester, example 3 | 2.0% |
| carboxymethylcellulose | 1.2% |
| EDTA | 0.2% |
| optical brightener | 0.2% |
| sodium sulfate | ad 100% |
| water | 9.8%. |

Color Washing Powder, Phosphate-Free without Bleaching Agent

| | |
|---|---|
| alkyl benzene sulfonate, sodiumd salt | 11.5% |
| C₁₂-C₁₈-alcohol ethoxylate with 7 EO | 6.0% |
| soap | 4.5% |
| foam inhibitor DC2-4248S, Dow Corning | 5.0% |
| polyester, example 6 | 2.0% |
| zeolite 4A | ad 100% |
| soda | 15.0% |
| polycarboxylate (Sokalan ® CP5) | 3.0% |
| sodium silicate | 4.0% |
| carboxymethylcellulose | 1.6% |
| phosphonate (Dequest 2066) | 2.08% |
| protease | 0.5% |
| polyvinylpyrrolidone | 0.5% |
| sodium sulfate | 9.4%. |

1. Polyester comprising structural units of formula Ia and end groups of formulae II and III or end groups of formulae II and IV or end groups of formulae II, III and IV or comprising structural units of formulae Ia and Ib and end groups of formulae II and III or end groups of formulae II and IV or end groups of formulae II, III and IV 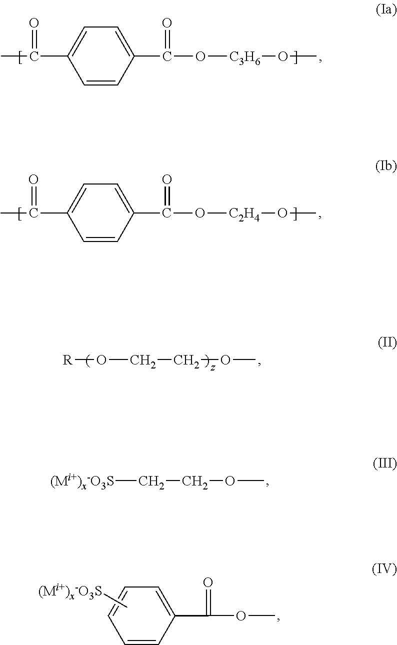
wherein R is C₁-C₄-alkyl,
M is hydrogen or a mono- or divalent cation,
i is 1 or 2,
x is 0.5 or 1 and the product i·x is equal to 1, and
z is an integer from 3 to 35.

2. The polyester according to claim 1, wherein this contains besides structural units of formula Ia or of formulae Ia and Ib and end groups of formulae II and III or of formulae II and IV or of formulae II, III and IV the structural units of formula Va and/or formula VIa or the structural units of formulae Va and Vb and/or of formulae VIa and VIb 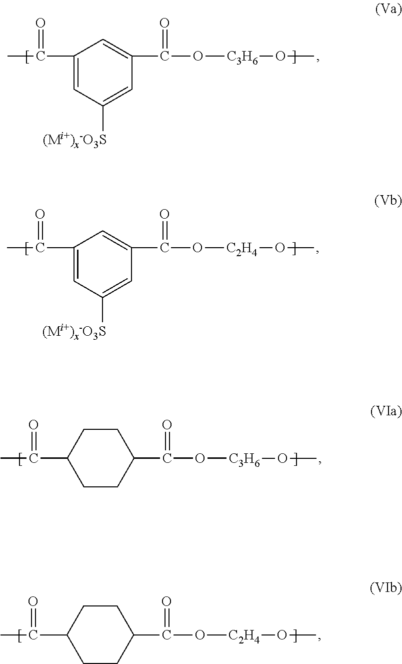
wherein M is hydrogen or a mono- or divalent cation,
i is 1 or 2,
x is 0.5 or 1 and the product i·x is equal to 1.

3. The polyester according to claim 1, wherein the polyester has a weight average of molecular weight from 2.000 to 20.000 g/mol.

4. The polyester according to according to claim 1, wherein the polyester contains >4 terephthalate units of formula Ia or of combined formulae Ia and Ib, preferred >=6 terephthalate units of formula Ia or of combined formulae Ia and Ib.

5. The polyester according to at according to claim 1, wherein the polyester contains the structural units of formula Ia or of formulae Ia and Ib and end groups of formula II, wherein R is a methyl group and index z is a number from 3 to 35.

6. The polyester according to claim 1, wherein index z is a number from 10 to 20.

7. The polyester according to claim 1, wherein index z is a number from 12 to 18.

8. The polyester according to claim 1, wherein the polyester contains the structural units of formula Ia or of formulae Ia and Ib and end groups of formula II and end groups of formula III.

9. The polyester according to claim 1, wherein the polyester contains the structural units of formula Ia or of formulae Ia and Ib and end groups of formulae II, III and IV.

10. The polyester according to claim 1, wherein the polyester contains the structural units of formula Ia or of formulae Ia and Ib and end groups of formulae II and III, wherein these end groups are derived from the reaction with polyethylene glycol monomethyl ether and isethionic acid or of one of its salts in the molar ratio II to III from 1 to 50 to 50 to 1.

11. The polyester according to claim 2, wherein the polyester contains the structural units of formulae Ia and Va or the structural units of formulae Ia, Ib, Va and Vb.

12. The polyester according to claim 2, wherein the structural units of formulae Ia and Va are present in the molar ratio I to V from 1 to 1 to 10 to 1, preferably from 2 to 1 to 5 to 1 or wherein the structural units of formulae Ia, Ib, Va and Vb are present in the molar ratio Ia+Ib to Va+Vb from 1 to 1 to 10 to 1.

13. The polyester according to claim 1, wherein group —SO₃⁻(Mⁱ⁺)ₓ in the end group of formula IV is in 3-position and M is hydrogen or an alkali metal cation, i is 1 and x is 1.

14. The polyester according to claim 1, wherein the polyester contains end groups of formula II, wherein R is a methyl group and index z is a number from 10 to 20.

15. The polyester according to claim 1, wherein the polyester is not crosslinked.

16. The polyester according to claim 2, wherein the polyester contains structural units of formulae Ia and Va and end groups of formulae II and III, but no end group of formula IV and no structural unit of formula VIa, or the polyester contains structural units of formulae Ia, Ib, Va and Vb and end groups of formulae II and III, but no end group of formula IV and no structural units of formulae VIa and VIb.

17. Process for the manufacture of the polyester according to a to claim 1, wherein
a) terephthalic acid dimethyl ester,
b) propylene glycol or ethylene glycol and propylene glycol,
c) polyethylene glycol monomethyl ether with a weight-average molecular weight in the range between 174 and 1555 g/mol, preferably between 500 and 800 g/mol and very preferred of 550 g/mol or of 750 g/mol,
d) isethionic acid or one of its salts, preferably its alkaline- or earth alkali metal salts and/or
e) sulfobenzoic acid, salts, preferably its alkali- or earth alkali metal salts, preferably 3-sulfobenzoic acid sodium salt
f) optionally sulfoisophthalic acid dimethylester and
g) optionally 1,4-cyclohexane dicarboxylic acid dimethylester
are reacted with one another wherein preferably besides components a), b), c) and d) or besides the components a), b), c) and e) or besides the components a), b), c), d) and e) at least one of the components f) and/or g) are additionally reacted.

18. The process according to claim 17, wherein the mixture of monomers a) and b) and of components c) and d) and/or e) additionally contains at least one of the monomers
sulfoisophthalic acid dimethylester, preferably 5-sulfoisophthalic acid-dimethylester, and/or
1,4-cyclohexane dicarboxylic acid or one of its salts, preferably one of alkaline or earth alkali metal salts, and/or a crosslinker.

19. In a method of washing, cleaning or textile conditioning, the improvement comprising utilizing the polyester according to claim 1 in washing and cleaning agents, in textile care products or in products for textile finishing.

20. In a method of washing or cleaning, the improvement comprising utilizing the polyester according to claim 1 as soil-release polymers.
